(19) United States
(12) Patent Application Publication
(10) Pub. No.: US 2026/0189072 A1
(43) Pub. Date: Jul. 2, 2026

(54) SECONDARY RESONANT CIRCUIT

(71) Applicant: VALEO ELECTRIFICATION, Cergy Pontoise (FR)

(72) Inventors: Nicolas ALLALI, Cergy Pontoise (FR); Geoffrey DEVORNIQUE, Saint-Quentin-Fallavier (FR)

(73) Assignee: VALEO ELECTRIFICATION, Cergy Pontoise (FR)

(21) Appl. No.: 19/116,414

(22) PCT Filed: Sep. 22, 2023
(86) PCT No.: PCT/EP2023/076297

§ 371 Date: Mar. 28, 2025

(30) Foreign Application Priority Data
Sep. 30, 2022 (FR) FR2209978

(51) Int. Cl. H02J 50/12; B60L 53/122; B60L 53/22; B60L 55/00; H02J 50/00

(52) U.S. Cl. CPC H02J 50/12; B60L 53/122; B60L 53/22; B60L 55/00; H02J 50/005; B60L 2210/10; B60L 2210/30

(57) ABSTRACT

A secondary resonant circuit for wireless power transmission in a recharging mode by way of resonant inductive coupling with a primary resonant circuit includes at least a first capacitor and a first inductance. The power transmission is directed to the resistive load coupled to the secondary resonant circuit, the resistive load having an equivalent impedance. The secondary resonant circuit includes a second capacitor of value Cs and a second inductance of value Ls, magnetically and partially coupled to the first capacitor and the first inductance, and a decoupling assembly.

The present invention relates to a secondary resonant circuit.

The present invention relates to a secondary resonant circuit and to a device for contactlessly transmitting power by resonant inductive coupling, notably in order to charge or recharge a battery of a motor vehicle or any type of land, air or sea vehicle propelled by means of electrical energy.

As known per se, it is technically possible to supply, by contactless transmission, a motor vehicle or any other object provided with an electrical energy storage device with power of between 3 and 50 kW, when this object is stationary (static charging is spoken of in this case) or when it is moving (dynamic charging is then spoken of). This supply via contactless transmission is then achieved by means of distant electrical circuits which are magnetically coupled and tuned to the same frequency. The magnetically coupled circuits each comprise at least one resonant LC element, L and C denoting inductors and capacitors, respectively.

One problem with this type of solution is that, in order to transmit a satisfactory power level, notably several kW, it is necessary to operate at high frequencies, notably of the order of 85 kHz or more, for the resonant frequency of each resonant subcircuit. Furthermore, this type of solution makes it necessary to operate at a small distance between the resonant elements located in the source and in the load.

The frequency and power levels mentioned above, for a kWatt implementation, may, furthermore, constitute a danger to the health of the people exposed nearby, or to the environment in general.

Application US2011/0204845 discloses contactlessly recharging an electric vehicle by resonant inductive coupling at a frequency of between 60 Hz and 1200 Hz. This application does not specify, however, the nature of the electrical components which make contactless recharging by inductive coupling possible in this frequency range.

The present invention notably proposes to recharge an electric vehicle, or other on-board electrical storage system, at a very low transfer frequency, optionally with a reversible power flux.

One subject of the invention is thus a secondary resonant circuit for performing, in a recharging mode, a contactless power transmission by resonant inductive coupling, with a primary resonant circuit comprising at least a first capacitor and a first inductor, this power transmission being directed toward the resistive load coupled to the secondary resonant circuit, this secondary resonant circuit comprising:
a second capacitor and a second inductor, which are able to be coupled magnetically and partially to the first capacitor and to the first inductor,
a decoupling assembly comprising a rectifier arranged to provide a DC voltage in order to supply recharging power to the resistive load, and an impedance-matching unit which is arranged to vary the equivalent impedance at the input of this impedance-matching connection, independently of the impedance of the resistive load at the output of this impedance-matching connection.

The equivalent impedance at the input of the impedance-matching unit is represented by the ratio V/I where V is the voltage across the terminals of the impedance-matching unit and I is the intensity of the current flowing through it.

The invention thus makes it possible to perform contactless power transmission by low-frequency resonant inductive coupling, in contrast to the prior art, thus remedying the aforementioned drawbacks. The use of an impedance-matching unit makes it possible to increase the power transmitted, which is all the more favorable in a contactless transfer by low-frequency resonant inductive coupling. A simple and effective solution for increasing the power transmitted is thus obtained.

Preferably, the resonant pulsation of the primary circuit and secondary circuit is equal to 2.π.F₀, with F₀ being the pulsation frequency of a source in the primary circuit which supplies the recharging power.

The functions of rectification by the rectifier and of impedance matching by the impedance-matching unit may be performed by two distinct electronic stages or indeed by a single electronic stage.

According to one of the aspects of the invention, the source in the primary circuit has a sinusoidal or square AC voltage at a pulsation frequency F₀.

According to one of the aspects of the invention, this voltage drives a resonant circuit Lp/Cp, which is magnetically and partially coupled to a second resonant circuit Ls/Cs, the magnetic coupling coefficient of which coupling is denoted k.

The coupling coefficient k is in the range 0<k<1. It is noted that the coefficient k is linked to the mutual inductance by the relationship M²=k².Lp.Ls, which reflects the inductive coupling between two self-inductors.

According to one of the aspects of the invention, the frequency of power transfer between the primary circuit and the secondary circuit is less than 3 kHz, or even less than 2 kHz or 1 kHz, more notably substantially equal to 400 Hz or 50 Hz. The frequency range may be 50-2000 Hz. The frequency of power transfer between the primary circuit and the secondary circuit may, as a variant, be between 3 kHz and 5 kHz. As a variant, the frequency of power transfer between the primary circuit and the secondary circuit may be greater than 5 kHz, being, for example, of the order of 85 KHz.

The second capacitor and the second inductor may be connected in series, i.e. be arranged between two nodes of the secondary circuit. Such an arrangement makes it possible for the capacitance of the second capacitor to be independent of the aforementioned coupling coefficient k and to increase the power transfer further.

The secondary circuit may be devoid of controlled variable inductors, this variable inductor being arranged to be controlled so as to activate an effect of parametric amplification of the current in the secondary circuit. When the second capacitor and the second inductor are connected in series, this series connection may be received directly at the AC input of the decoupling assembly of the secondary circuit.

The invention makes it possible to transfer electric power from the source to the load in recharging mode.

Another subject of the invention is a device for contactlessly transmitting power by resonant inductive coupling, notably in order to charge or recharge a resistive load, such as a vehicle battery, with electrical energy, comprising:
a primary resonant circuit comprising a first capacitor and a first inductor, the primary resonant circuit being supplied with power by a voltage source;
a secondary resonant circuit as mentioned above, which receives, in recharging mode, electric power from the primary circuit, with a transfer frequency between the primary circuit and the secondary circuit which is less than 5 kHz, or even than 3 kHz, or even less than 2 kHz or 1 kHz, more notably substantially equal to 400 Hz or 50 Hz, or as a variant which is greater than 5 kHz, being notably equal to 85 kHz.

The first capacitor and the first inductor are, for example, connected in series.

The decoupling assembly may comprise two arms connected in parallel, each arm comprising two controllable switches in series, which are, for example, MOS transistors, and one of the arms may switch at the frequency of the power transmitted from the primary circuit and with a duty cycle of 50%, and the other arm may switch at a frequency which is greater than that of the power transmitted from the primary circuit, for example at a frequency which is equal to or greater than 5 times or 10 times the frequency of the power transmitted from the primary circuit, and with a duty cycle modulated according to the measured AC current and the voltage at the AC input of the decoupling assembly.

In conventional electric vehicle chargers, it is common practice to find a power reversibility function in order to participate in the function referred to as the smart grid function of an urban electrical grid.

According of one of the aspects of the invention, the device is arranged to be reversible in terms of power, making it possible for the secondary circuit to send power to the primary circuit, this power received in the primary circuit being able, for example, to be injected into an urban electrical grid.

According to one of the aspects of the invention, the device comprises, on the secondary circuit side, an on-board charger stage, notably of single-phase single-stage bidirectional on-board charger type, which is arranged to exchange electric power contactlessly with the secondary circuit in order to make an additional on-board wired recharging function possible.

In all of the above, the primary circuit may be integrated into a charging station of an electric or hybrid vehicle. This station then receives electrical energy from an electrical network via a cable, which may be a single-phase cable or a three-phase cable. In this case, the primary circuit and the secondary circuit are not integrated in one and the same physical component.

As a variant, the primary circuit and the secondary circuit may be integrated in one and the same physical component. Such a component, which is, for example, called a “charger”, may be installed on board a vehicle.

In all of the above, the resistive load may be a battery, the latter then having a nominal voltage of 12 V, 48 V, 60 V or more, for example greater than 300 V, for example 400 V, 800 V or 1000 V.

In all of the above, the first and/or second inductor may be made of metal wire, such as copper. Such a metal wire is solid, as opposed to Litz wire. A solid metal wire does not have its cross section hollowed out. As a variant, at least one of these inductors, or even each of these inductors, is made of Litz wire.

Other features, details and advantages of the invention will become clearer on reading the detailed description given below and examples of embodiments given by way of indication and not limitation with reference to the attached schematic drawings, in which:

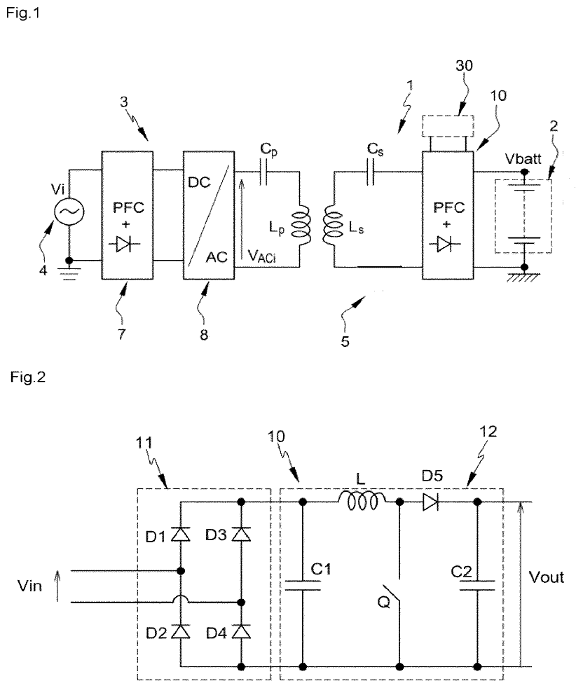

FIG. 1 is a schematic depiction of a device for contactlessly transmitting power by resonant inductive coupling according to an example of an implementation of the invention,

FIG. 2 schematically depicts the decoupling unit of the secondary circuit of the device of FIG. 1,

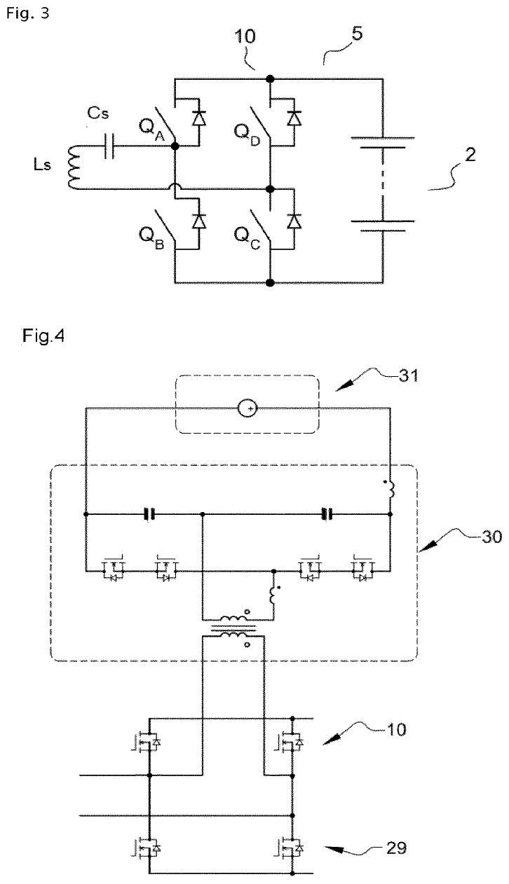

FIG. 3 schematically depicts a variant decoupling unit of the secondary circuit of the device of FIG. 1,

FIG. 4 schematically depicts an on-board charger stage connected to the device of FIG. 1.

FIG. 1 depicts a device 1 for contactlessly transmitting power by resonant inductive coupling, in order to charge or recharge a resistive load 2, here a vehicle battery, with electrical energy.

The device 1 comprises:
a primary resonant circuit 3 comprising a first capacitor Cp and a first inductor Lp, the primary resonant circuit 3 being supplied with power by a voltage source 4, here a domestic electrical network;
a secondary resonant circuit 5 which receives, in recharging mode, electric power from the primary circuit 3.

The primary circuit 3 furthermore comprises, after the source 4, a rectifier stage with a power factor corrector 7 or PFC rectifier 7 (PFC denoting power factor correction), followed by a DC-to-AC converter 8 which supplies a voltage V_{ACi}.

The source in the primary circuit has a sinusoidal or square AC voltage V_{ACi} at a pulsation frequency F₀.

The frequency is at 50 Hz in the example described.

The PFC rectifier stage 7 is used, on the one hand, to transform the alternating current (AC) into direct current (DC) and, on the other hand, to make it possible for the current drawn from the AC network 4 to be as close as possible to a perfect sine at the pulsation of the network. One of the aims is to reduce the reactive current and the subharmonics, which increase the conduction energy losses.

The secondary resonant circuit 5 is used to perform, in a recharging mode, a contactless power transmission by resonant inductive coupling, with the primary resonant circuit 3, this power transmission being directed toward the resistive load 2 coupled to the secondary resonant circuit 5, this resistive load 2 having an equivalent active impedance.

The secondary resonant circuit 5 comprises:
a second capacitor Cs of value Cs and a second inductor Ls of value Ls, which are coupled magnetically and partially to the first capacitor Cp and the first inductor Lp,
a decoupling assembly 10 arranged to decouple the equivalent impedance of the resistive load 2 from the recharging power.

As can be seen in FIG. 2, this decoupling assembly 10 may, in one example, comprise a rectifier 11 arranged to provide a DC voltage in order to supply recharging power to the resistive load 2, and an impedance-matching unit 12 which is arranged to vary the equivalent impedance at the input of this impedance-matching connection, independently of the equivalent active impedance of the resistive load at the output of this impedance-matching connection.

The rectifier 11 comprises, conventionally, four diodes D1 to D4.

The impedance-matching unit 12, or PFC, comprises two capacitors C1, C2 and a switch Q, all in respective parallel branches, and an inductor L and a diode D5.

This unit 12 sees at input a voltage rectified on the basis of the voltage Vᵢₙ and delivers at output a voltage Vₒᵤₜ which is, in the example described, equal to the voltage V_{batt} across the terminals of the resistive load.

The decoupling assembly 10 thus performs two functions. The first function is to rectify the AC current in order to convey a DC current to the battery 2. The second function is to ensure that the ratio of the voltage which is present at the input of the assembly 10 divided by the input current is equal to a reference impedance R. In other words, this assembly 10 transforms the rectification coupled to the battery into an equivalent resistance as seen from the on-board resonant mesh on the vehicle side.

The aim of this regulation of equivalent load impedance is to place the resonant mesh in an arrangement which is favorable to the establishment of a current in order to maximize the transfer of power to the battery. The reference value of this load is a compromise. It must be high enough not to require a lot of current in order to transfer power. It must be low enough to guarantee that, at the input of this assembly, the voltage is strictly lower than the battery voltage, otherwise the system would be out of control and regulation becomes impossible.

The resonant pulsation of the primary circuit 3 and secondary circuit 5 is equal to 2.π.F₀, with F₀ being the pulsation frequency of the source in the primary circuit 3 which supplies the recharging power.

The functions of rectification by the rectifier 11 and of impedance matching by the impedance-matching unit 12 may be performed by two distinct electronic stages, as illustrated in FIG. 2, or indeed within a single electronic stage, as illustrated in FIG. 3.

The assembly 10 may be an electronic assembly of “Totem POLE PFC rectifier” or “dual boost PFC rectifier” type, these assemblies being known in the electronic literature for their structure.

In the example of FIG. 3, the assembly 10 constitutes a single electronic stage which performs both voltage rectification and impedance matching by means of two arms 20 connected in parallel. Each arm comprises two controllable switches in series which are, for example, MOS transistors. One of the two arms switches at the frequency of the power transmitted from the primary circuit and with a duty cycle of 50%, and the other arm switches at a frequency which is greater than that of the power transmitted from the primary circuit, for example at a frequency which is equal to or greater than 5 times or 10 times the frequency of the power transmitted from the primary circuit, and with a duty cycle modulated according to the measured AC current and the voltage at the AC input of the assembly 10.

The impedance-matching assembly 10 of FIG. 3 is arranged to vary the equivalent impedance R_{Ref} at the terminals of the AC input, defined between the two midpoints of the arms, independently of the impedance of the resistive load at the output of this assembly 10.

The equivalent impedance R_{Ref} is represented by the ratio V/I where V is the voltage across the terminals of the AC input and I is the current intensity at this AC input.

R_{Ref} has, for example, a value of between 5′Ω and 15′Ω. For a given recharging configuration, this configuration being notably determined by at least one of: the position of the secondary resonant circuit 5 in relation to the primary resonant circuit 3 and/or the level of power to be transmitted and/or the voltage across the terminals of the battery, R_{Ref} may have a fixed value and this value is, for example, in the aforementioned range. From one recharging configuration to another, for example in the event of greater distance between the primary resonant circuit 3 and the secondary resonant circuit 5 and/or to take account of the aging of the system, the value of R_{Ref} may be modified, remaining notably in the aforementioned range.

One of the controllable switches of the arm which switches at a frequency which is greater than that of the power transmitted from the primary resonant circuit 3 is, for example, controlled with a duty cycle α, while the other controllable switch of this arm is controlled with a duty cycle 1−α, and α is, for example, determined according to the equation below ∝=^{R}Ref×|I|/V_{batt}

The voltage V_{ACi}, referred to as the source voltage, at the output of the converter 8 drives a resonant Lp/Cp cell, which is magnetically and partially coupled to a resonant Ls/Cs cell of the secondary resonant circuit, the magnetic coupling coefficient of which coupling is denoted k.

The coupling coefficient k is in the range 0<k<1.

The frequency of power transfer between the primary circuit and the secondary circuit is less than 5 kHz, or even less than 3 kHz, or even less than 2 kHz or 1 kHz, more notably substantially equal to 400 Hz or 50 Hz. This transfer frequency is notably that applied to the resonant LC cell of the primary circuit.

The invention makes it possible to transfer electric power from the source VACi to the load 2 in recharging mode.

According to one of the aspects of the invention, the device comprises, on the secondary circuit side, an on-board charger stage 30, notably of single-phase single-stage bidirectional on-board charger type, which is arranged to exchange electric power contactlessly with the secondary circuit in order to make an additional on-board wired recharging function possible.

This on-board charger stage 30, known per se, is depicted in dotted lines in FIG. 1.

This on-board charger stage 30 is of isolated AC-to-DC converter type, which integrates the functions of rectifier, notably at 50 Hz, of PFC and high-frequency inverter with a single MOSFET input stage.

As illustrated in FIG. 4, this on-board charger stage 30 is connected to a rectifier bridge 29 of the decoupling assembly 10 which comprises the impedance-matching unit 12, which is present in parallel with the battery.

This stage 30 serves an on-board network 31 which makes wired recharging possible.

1. A secondary resonant circuit for performing, in a recharging mode, a contactless power transmission by resonant inductive coupling, with a primary resonant circuit comprising at least a first capacitor and a first inductor, this power transmission being directed toward the resistive load coupled to the secondary resonant circuit this secondary resonant circuit comprising:
a second capacitor of value Cs and a second inductor of value Ls, which are able to be coupled magnetically and partially to the first capacitor and to the first inductor, and
a decoupling assembly, this decoupling assembly comprising a rectifier arranged to provide a DC voltage in order to supply recharging power to the resistive load, and an impedance-matching unit which is arranged to vary the equivalent impedance at the input of this impedance-matching unit, independently of the impedance of the resistive load at the output of this impedance-matching unit.

2. The circuit as claimed in claim 1, wherein the frequency of power transfer between the primary circuit and the secondary circuit is less than 5 kHz, or even less than 3 kHz, or even less than 2 kHz or 1 kHz, more notably substantially equal to 400 Hz or 50 Hz.

3. The circuit as claimed in claim 1, wherein the functions of rectification by the rectifier and of impedance matching by the impedance-matching unit are performed by two distinct electronic stages.

4. The circuit as claimed in claim 1, wherein the functions of rectification and of impedance matching are performed by a single electronic stage.

5. The circuit as claimed in claim 1, the second capacitor and the second inductor being connected in series.

6. The circuit as claimed in claim 1, the second inductor being made of metal wire other than Litz wire.

7. A device for contactlessly transmitting power by resonant inductive coupling, notably in order to charge or recharge a resistive load, such as a vehicle battery, with electrical energy, comprising:
a primary resonant circuit comprising a first capacitor and a first inductor, the primary resonant circuit being supplied with power by a low-frequency energy source;
a secondary resonant circuit as claimed in claim 1, which receives, in recharging mode, electric power from the primary circuit, with a transfer frequency between the primary circuit and the secondary circuit which is less than 5 kHz, or even less than 3 kHz, or even less than 2 kHz or 1 kHz, more notably substantially equal to 400 Hz or 50 Hz, or which is greater than 5 kHz, being notably substantially equal to 85 kHz.

8. The device as claimed in claim 7, the first capacitor and the first inductor being connected in series.

9. The device as claimed in claim 7, the first inductor being made of metal wire other than Litz wire.

10. The device as claimed in claim 7, the decoupling assembly comprising two arms connected in parallel, each arm comprising two controllable switches in series, and one of the arms switching at the frequency of the power transmitted from the primary circuit and with a duty cycle of 50%, and the other arm switching at a frequency which is greater than that of the power transmitted from the primary circuit, notably at a frequency which is equal to or greater than 5 times or 10 times the frequency of the power transmitted from the primary circuit, and with a duty cycle modulated according to the measured AC current and the voltage at the AC input of this decoupling assembly.

11. The device as claimed in claim 7, arranged to be reversible in terms of power, making it possible for the secondary circuit to send power to the primary circuit, this power received in the primary circuit being able, for example, to be injected into an urban electrical grid.

12. The circuit as claimed in claim 2, wherein the functions of rectification by the rectifier and of impedance matching by the impedance-matching unit are performed by two distinct electronic stages.

13. The circuit as claimed in claim 2, wherein the functions of rectification and of impedance matching are performed by a single electronic stage.

14. The circuit as claimed in claim 2, the second capacitor and the second inductor being connected in series.

15. The circuit as claimed in claim 2, the second inductor being made of metal wire other than Litz wire.

16. A device for contactlessly transmitting power by resonant inductive coupling, notably in order to charge or recharge a resistive load, such as a vehicle battery, with electrical energy, comprising:
a primary resonant circuit comprising a first
capacitor and a first inductor, the primary resonant circuit being supplied with power by a low-frequency energy source;
a secondary resonant circuit as claimed in claim 2, which receives, in recharging mode, electric power from the primary circuit, with a transfer frequency between the primary circuit and the secondary circuit which is less than 5 kHz, or even less than 3 kHz, or even less than 2 kHz or 1 kHz, more notably substantially equal to 400 Hz or 50 Hz, or which is greater than 5 kHz, being notably substantially equal to 85 kHz.

17. The device as claimed in claim 8, the first inductor being made of metal wire other than Litz wire.

18. The device as claimed in claim 8, the decoupling assembly comprising two arms connected in parallel, each arm comprising two controllable switches in series, and one of the arms switching at the frequency of the power transmitted from the primary circuit and with a duty cycle of 50%, and the other arm switching at a frequency which is greater than that of the power transmitted from the primary circuit, notably at a frequency which is equal to or greater than 5 times or 10 times the frequency of the power transmitted from the primary circuit, and with a duty cycle modulated according to the measured AC current and the voltage at the AC input of this decoupling assembly.

19. The device as claimed in claim 8, arranged to be reversible in terms of power, making it possible for the secondary circuit to send power to the primary circuit, this power received in the primary circuit being able, for example, to be injected into an urban electrical grid.

20. The circuit as claimed in claim 3, wherein the functions of rectification and of impedance matching are performed by a single electronic stage.
